(19) United States
(12) Patent Application Publication
(10) Pub. No.: US 2011/0104637 A1
(43) Pub. Date: May 5, 2011

(54) VARIABLY MOUNTABLE IMPLANT WITH STEPPED SOCKET

(75) Inventor: Bernard Weissman, New York, NY (US)

(73) Assignee: DENTATUS, USA, LTD., New York, NY (US)

(21) Appl. No.: 12/613,017

(22) Filed: Nov. 5, 2009

(51) Int. Cl. A61C 8/00

(52) U.S. Cl. 433/173

(57) ABSTRACT

An implant for supporting a prosthetic tooth in an anatomically correct shape of a maxillary and/or mandibular central or lateral incisor includes a post for securing to a mandible of a patient; an abutment; and a socket having a bifurcated stepped shape. The bifurcated stepped shape defines a schematic-anatomical analog to the maxillary and/or mandibular central or lateral incisor.

### BACKGROUND OF THE INVENTION

1. Field of the Invention

The present invention relates to improvements in prosthetic implants for implant dentistry.

2. Discussion of the Related Art

In implant dentistry, a replacement tooth is permanently secured to a patient's maxilla, i.e., upper jaw, or the mandible, i.e., jaw bone, by taking advantage of the body's willingness to osseointegrate certain materials. The replacement tooth comprises an implant, typically made of titanium, which is secured into an opening, i.e., osteotomy, which has been previously prepared by a dentist or dental surgeon, i.e., dentist, in the patient, i.e., implant site. In due course, the natural bone adheres to the implant. After a certain period, a physiologically correct crown is secured to the crown socket of the implant to provide a prosthetic tooth that can be used like a natural tooth.

A satisfactory implantation meets two conditions: (1) an implant secured to solid bone and (2) properly aligning the crown of the implant (or the crown of a bridge supported by one or more implants) relative to the crown of the adjacent teeth to meet the patient's functional and aesthetic needs.

Replacing an anterior incisor, i.e., front teeth, is especially difficult due to the topography of the maxilla with a ridge and shovel shape of the incisor. In fact, when a maxillary incisor is lost, the maxillary ridge shrinks substantially to the level and space of the extracted teeth. As a result of this, the prosthetic crowns and bridges are compromised (a) functionally whether they do no properly occlude in contact with the opposing teeth (b) aesthetically; their set back position is likewise compromised as they cannot support the facial anatomy, flattening out the lip and mouth structure to an unnatural looking position. To make up for the loss of bone, lengthy and very costly bone replacement procedures must be performed to replace the missing bone.

In FIG. 1a, line 2a is a longitudinal axis through across-section of a “typical” maxilla 1, i.e., “jaw axis.” In the idealized drawing, a longitudinal axis 4a through an anterior incisor 3a, i.e., “tooth axis,” is coincident with longitudinal axis 2a through a cross-section of the maxilla. However, when the maxilla has shrunk or when a functional and/or aesthetic crown alignment requires a specific position of crown 6, jaw axis 2a and tooth axis 4a may be offset via an angle 8a, as depicted in FIG. 1b. In traditional implant dentistry, the dentist must compensate between positioning the implant along the jaw axis 2a or tooth axis 4a to locate crown 6a correctly.

Typically, an implant 10a is positioned along the jaw axis 2 (FIG. 1b). An angled piece 12a is then mounted on to the head of the implant to compensate for the offset angle 8a. In turn, the crown 6 in the desired shape of an incisor is then secured to the angled piece rather than the head of the implant.

Using multiple pieces successively secured to the head of the implant is undesirable for reasons of economy and safety of the patient. The situation is exacerbated by the particular shovel shape of a typical maxillary incisor. A surface 14a of the tooth on the lingual side curves significantly narrowing the thickness 16a of the crown between the angled piece 12a and the rear surface of the crown.

Replacing a mandibular central or lateral incisor is equally difficult due to the cross-sectional shape of the mandible and the shovel shape of the incisor. A human mandible includes a curved portion called the body of the mandible. A thickening on the top surface of the apex of the body of the mandible, i.e., coincident to the midline of the face, is called the alveolar bone, sometimes the alveolar process. It contains the tooth sockets of the teeth of the lower jaw. A particular aspect of the alveolar bone and the body of the mandible is that in cross-section at and near the apex of the body has an irregular shape as depicted in FIG. 1c.

In a “typical” mandible, the alveolar bone is inward of the mental protuberance, i.e., chin, creating an angle with respect to the teeth 3b, i.e., the mandibular central incisors, socketed in the bone. For example in FIG. 1c, line 2b is a longitudinal axis through a cross-section of the alveolar bone 1, i.e., “jaw axis”, and line 4b is a longitudinal axis through mandibular incisor, i.e., “tooth axis.” The axes intersect at an offset angle 8b in a cross-sectional plane of the mandible.

Thus, in traditional implant dentistry, the dentist must choose between positioning the implant along the tooth axis 4b and the jaw axis 2b, respectively FIGS. 1d and 1e. Installing an implant 10b along tooth axis 4b may not be readily possible if the patient's mandible is atypical. In such situations, the implant may break through the mandible (FIG. 1d).

Thus, often implant 10b is positioned along the jaw axis 2b (FIG. 1e). An angled piece 12b is then mounted on to the head of the implant to compensate for the offset angle 8b. In turn, the crown 6b in the shape of an incisor is then secured to the angled piece rather than the head of the implant.

Using multiple pieces successively secured to the head of the implant is undesirable in itself. The situation is exacerbated by the particular shovel shape of a typical mandibular central or lateral incisor. A surface 14b of the tooth on the lingual side curves significantly narrowing the thickness 16b of the crown between the angled piece 12b and the rear surface of the crown.

Thus, what is desired is an implant which avoids the issues known in the art with respect to replacing maxillary and/or mandibular central or lateral incisor. What is also desired is an implant that may be used variably.

### SUMMARY OF THE INVENTION

These and other needs are met by the present invention. Therein, an implant for supporting a prosthetic tooth in an anatomically correct shape of a maxillary and/or mandibular central or lateral incisor includes a post for securing to a mandible of a patient; an abutment; and a socket having a bifurcated stepped shape. The bifurcated stepped shape defines a schematic-anatomical analog most preferable to a maxillary and/or mandibular central or lateral incisor.

The invention may also be readily used with respect to other teeth such as molars. In particular, the present invention may be used where such molars or other teeth are leaning and a natural crown cannot be readily achieved because typical implants cannot be anchored in solid bone. Therein, the analog may have a suitable bifurcated stepped shape that is suitable for a molar or the type of tooth being replaced.

A key is received in a socket and may be used in conjunction with a tool for manipulating the implant and/or as a support in a prosthetic tooth. The key includes one or more lateral protrusions that are seated in respective lateral channels of the socket for a positive fit.

### BRIEF DESCRIPTION OF THE DRAWINGS

FIG. 1a is a cross-sectional view through a maxilla.

FIG. 1b is a schematic cross-sectional diagram of an implant installation along a jaw axis in a partial maxilla.

FIG. 1c is a cross-sectional view through a mandible.

FIG. 1d is a schematic cross-sectional diagram of an implant installation along a tooth axis in a partial mandible.

FIG. 1e is a schematic cross-sectional diagram of an implant installation along a jaw axis in a partial mandible.

FIG. 2a is a side view of an implant in accordance with one or more embodiments of the present invention.

FIG. 2b is a front view of the implant of FIG. 2a.

FIG. 2c is a planar view of the implant of FIG. 2a.

FIG. 3a is a first cross-sectional view of a key associate with the implant of FIG. 2a in accordance with one or more embodiments of the present invention.

FIG. 3b is a front view of the key of FIG. 3a.

FIG. 3c is a second view of the key of FIG. 3a.

FIG. 3d is a planar top view of the key of FIG. 3a.

FIG. 4a is a schematic cross-section of a maxilla wherein an implant of the present invention has been installed in a first position in accordance with one or more embodiments of the present invention.

FIG. 4b is a schematic cross-section of a maxilla wherein an implant of the present invention has been installed in a second position in accordance with one or more embodiments of the present invention.

FIG. 5a is a schematic cross-section of a mandible wherein an implant of the present invention has been installed in accordance with one or more embodiments of the present invention.

FIG. 5b is a schematic cross-section of a prosthetic tooth comprising a key in accordance with one or more embodiments of the present invention.

FIG. 5c is schematic cross-section of a mandible wherein the prosthetic tooth of FIG. 4b has been installed on the implant of FIG. 4a in accordance with one or more embodiments of the present invention.

FIG. 6 is a planar view of a mandible wherein an implant of FIG. 2a has been installed in a first and a second direction in accordance with one or more embodiments of the present invention.

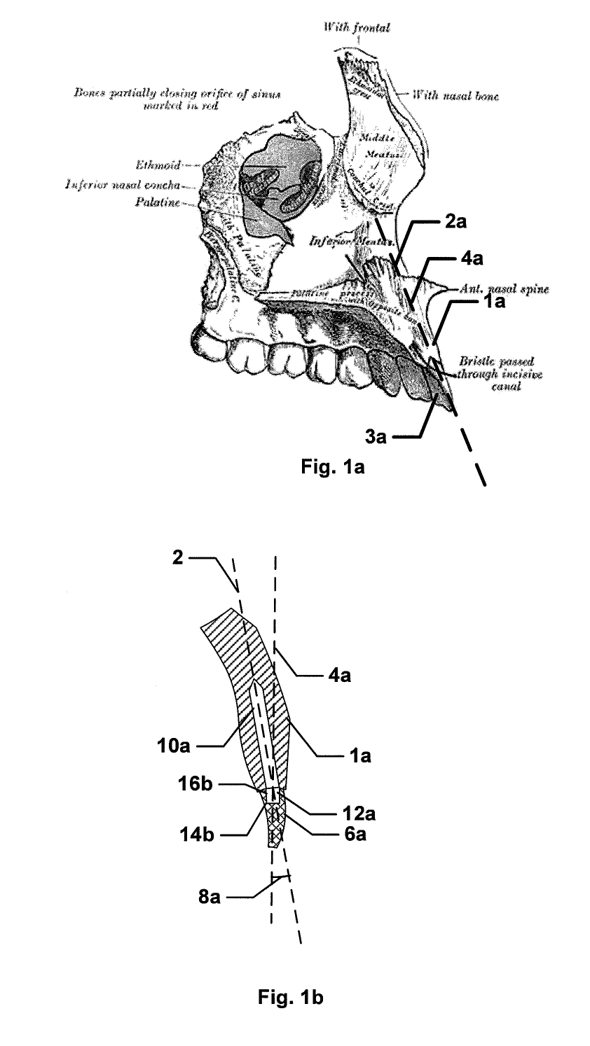

### DETAILED DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

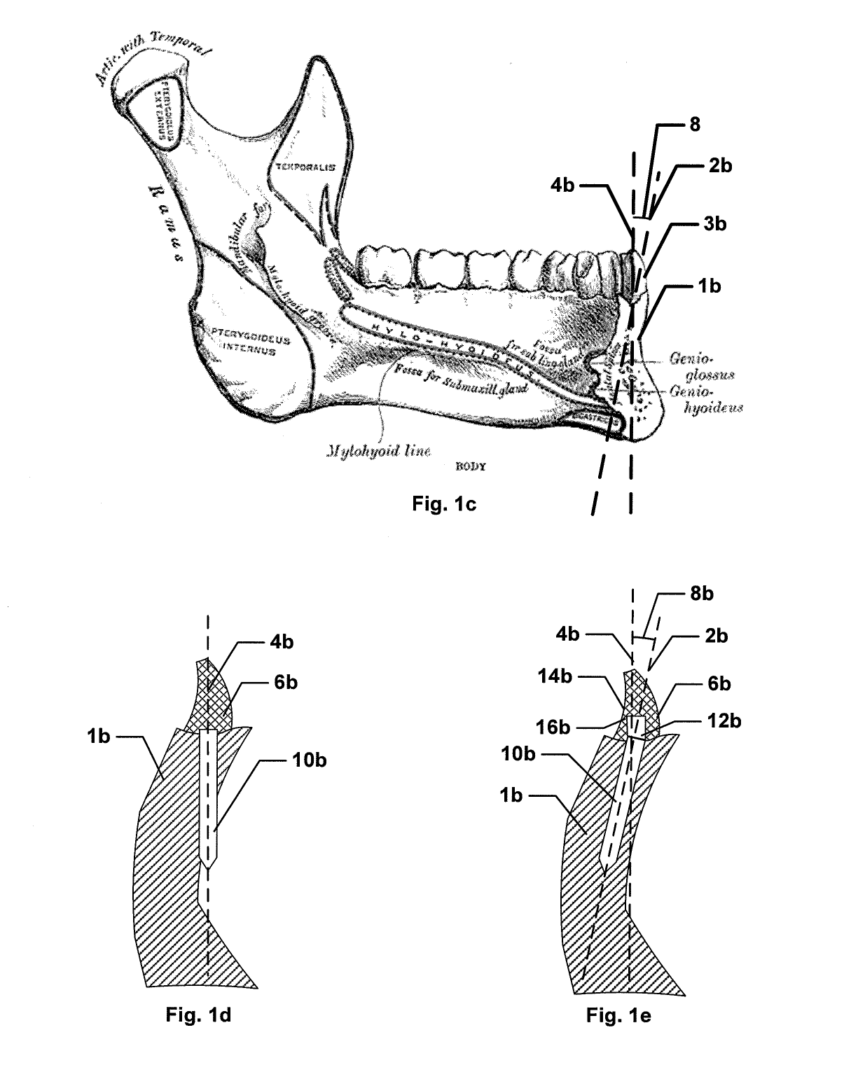

FIG. 2a is a side view of an implant in accordance with one or more embodiments of the present invention. FIG. 2b is a front view of the implant of FIG. 2a. FIG. 2c is a planar view of the implant of FIG. 2a.

In accordance with one or more embodiments of the present invention, an implant 20 for supports a prosthetic tooth in an anatomically correct shape of a maxillary or mandibular central or lateral incisor. The implant includes a fully or partially threaded post 22, an abutment 24, and a head portion, i.e., crown socket 26.

Post 22 may be any suitable portion that is known in the art, but is preferably one made according to the teachings of U.S. Pat. No. 5,785,525 and/or 6,685,473, which are herein incorporated in their entirety for all purposes.

Therein, post 22 preferably comprises a distal end 22a for being received first in a patient's mandible as is known in the art. A shank 22b includes a threaded portion 22c having a helical thread or other thread known in the art and preferably is self-tapping. An unthreaded, e.g., bare, portion 22d may be provided spaced from the distal end.

Abutment 24 may be any suitable type of abutment that is known in the art, but is preferably one made according to the teachings of U.S. Pat. No. 5,785,525 and/or 6,685,473, which are herein incorporated in their entirety for all purposes.

Preferably, abutment 24 is circular in cross-section and comprises a base 24a adjoining post 22 and may be integral with it. A floor 24b may be disposed spaced from base 24a and one or more comprise lateral channels 24c formed between the lateral walls of the socket and one or more lateral edge portions of the abutment. Abutment 24 comprises the lateral edge portions 24d and one or more transverse edge portions 24e that contact the gingiva along a generally curved outer surface 24f overhanging post 22.

The outer surface 24f is suitably sized to permit it to be placed within the crown, i.e., prosthetic tooth, and to be cemented. The ability of the prosthetic tooth to fit over surface 24f permits the tooth to be adjusted relative to the implant, as discussed further below. This also creates a condition where the solid implant can be threaded in and installed in a very narrow, for example, 3.5 mm, inter-root tooth spaces and then cementing the cementing the customized crowns over it. Moreover, a uniform abutment coping permits indexing of the position of the implant in order to create a working model as used in known technical crown-forming procedures.

Socket 26 receives a key embedded in a prosthetic tooth or associated with a tool. The socket is preferably integrally joined to the abutment and comprises a bifurcated stepped shape 27 having notched area 27a defined by a first extension 28 and a second extension 30 separated from each other by a depression 32. The birfurcated stepped shape defines a schematic-anatomical analog to a maxillary and/or mandibular central or lateral incisor.

Advantageously, the first and second extensions 28, 30 are sized relative to each other to fit more anatomically correct within a prosthetic tooth shaped to be a maxillary and/or mandibular central or lateral incisor shape when mounted in a first direction generally perpendicular to the maxilla or the mandible. When mounted in a second direction wherein the extensions are in-line to the mandible, implant 20 may used for a prosthetic tooth that is not a maxillary and/or mandibular central or lateral incisor, but, for example, a molar.

The invention may also be readily used with respect to other teeth such as molars. In particular, the present invention may be used where such molars or other teeth are leaning and a natural crown cannot be readily achieved because typical implants cannot be anchored in solid bone.

Therein, the analog may have a suitable bifurcated stepped shape that is suitable for a molar or the type of tooth being replaced.

Socket 26 comprises lateral walls 26a and 26b that are canted inwards toward each other to hypothetically intersect distal from floor 24b and comprise the lateral surfaces of the first and second extension at preferably a 6.40 degree angle. Lateral walls 26a and 26b are spaced further apart at the first extension and then narrow at the second extension.

First extension 28 comprises a transverse wall 28a having an upright portion 28b that is perpendicular to floor 24b. A canted wall portion 28c extends from upright portion 28b and connects via a peak 28d to an angled transverse wall 28e extending from depression 32. The transverse walls are bounded by lateral walls 26a, 26b in the lateral direction. Peak 28d is linear in a transverse direction, but preferably is rounded in a lateral direction, where it may have a radius of 0.5 mm. Therein, wall portion 28c has a 1 degree cant from the upright wall portion 28b and a length of 5.0 mm, while upright wall portion 28b has a height of 2.20 mm.

Second extension 30 is smaller than the first extension, i.e., first extension 28 is more distal from floor 24b of the abutment than second extension 30. Second extension 30 comprises a transverse wall 30a that is perpendicular to floor 24b and an angled transverse wall 30b and intersect at a peak 30c. Preferably, angled transverse wall 30b intersects upright transverse wall 30a at a 45 degree angle. The transverse walls are bounded by lateral walls 26a, 26b in the lateral direction. Peak 30c is preferably spaced 3.10 mm from floor 24b. Peak 30c and a tangential point on the curve of peak 28d has an angle of 27.30 degrees with respect to a line perpendicular through floor 24b.

Depression 32 comprises a transverse trough having preferably a radius of 0.25 mm, which is the diameter of a drill. This provides the advantage of key form installation with sufficient space for a narrow crown, i.e., prosthetic tooth. The bottom of the through is preferably spaced 4.75 mm from the topmost portion of peak 28d.

Implant 20 may be made of a solid titanium alloy having 1.8 mm to 2.8 mm diameter and is 3-4 mm in length.

A crown can e constructed with conventional dental laboratory procedures in material of choice, such as, but not limited to metal, ceramic, and dental resin material.

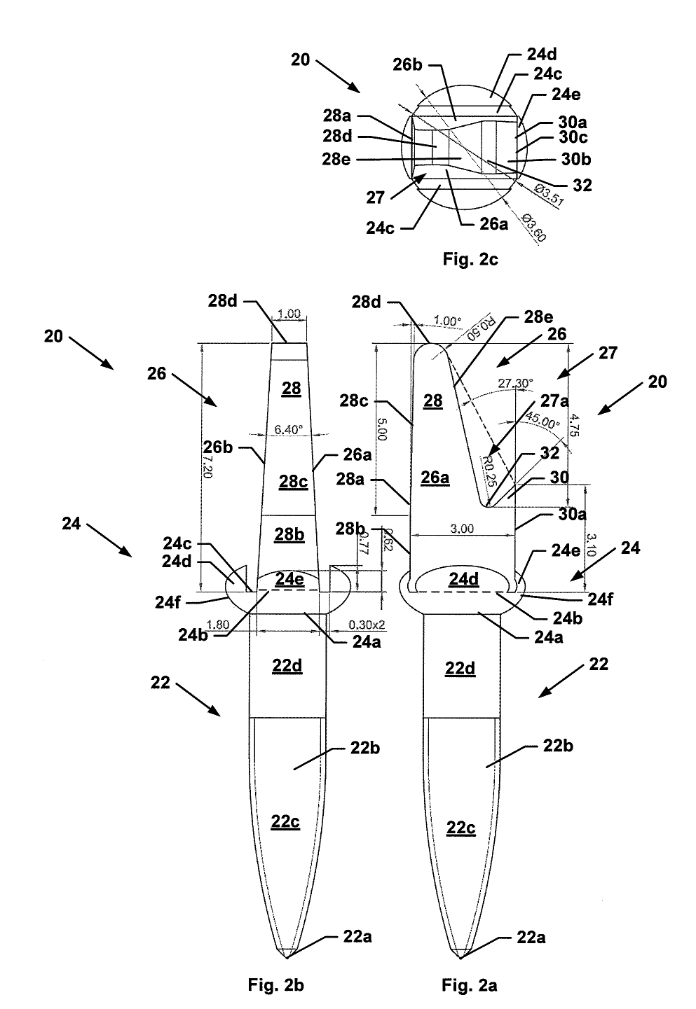

FIG. 3a is a first cross-sectional view of a key associate with the implant of FIG. 2a in accordance with one or more embodiments of the present invention. FIG. 3b is a front view of the key of FIG. 3a. FIG. 3c is a second view of the key of FIG. 3a. FIG. 3d is a planar top view of the key of FIG. 3a.

A key 40 for being received by socket 26 may be used in conjunction with a tool for manipulating implant 20 and/or as a support in a prosthetic tooth 60. Key 40 includes one or more lateral protrusions 42 that are seated in respective lateral channels 24c for a positive fit. A body 44 comprises a one or more lateral walls 44a and one or more transverse walls 44b. Preferably, walls 44a are not canted or angled to match the lateral and transverse wall, expect with respect to notched area 27a of socket 26, to permit easy mounting of the key on the socket.

A bitting 44c having a notched shape is connected to one or more walls 44 and defines a stepped void space 27b in the key. Void space 27b substantially identical in shape to the bifurcated shape 27 of socket 26. Thus, bitting 44c may be operatively received in notched area 27a to seat key 40, e.g., the associated tool and/or tooth 60, onto socket 26.

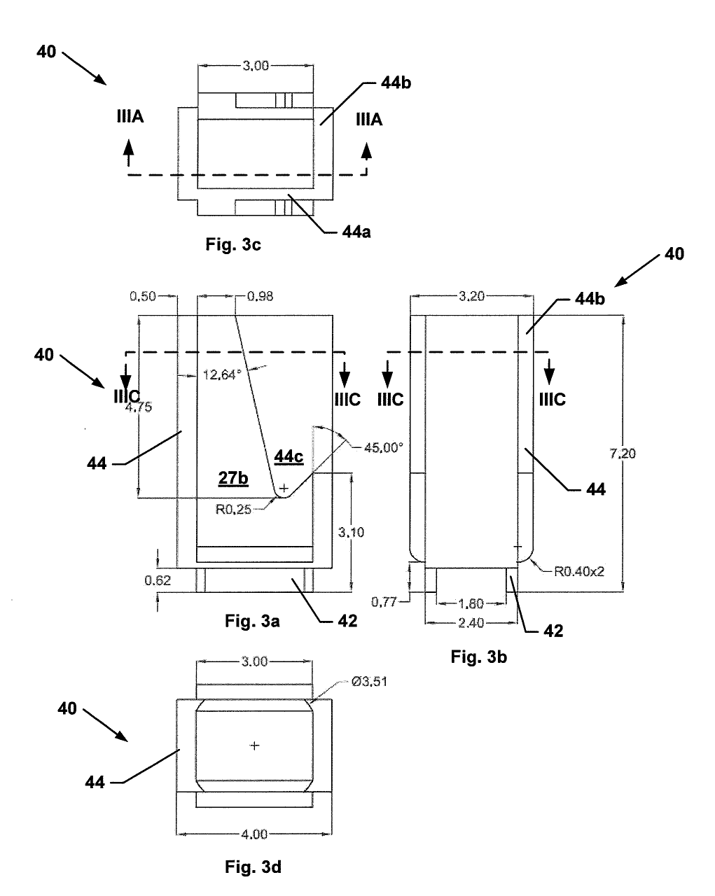

FIG. 4a is a schematic cross-section of a maxilla wherein an implant of the present invention has been installed in a first position in accordance with one or more embodiments of the present invention. FIG. 4b is a schematic cross-section of a maxilla wherein an implant of the present invention has been installed in a second position in accordance with one or more embodiments of the present invention.

When installing the implant for a maxillary incisor, implant 20 may be secured to the maxilla in a plurality of positions. In a first position (FIG. 4a), implant 20 has been installed along a jaw axis 2c such that second extension 30 is proximal the lingual side of the patient's mouth. In that position the first extension 28 causes a tooth axis 4c of a prosthetic tooth 60, which fitted to the implant, to be oriented along jaw axis 2c in a position 62a.

While this orientation may be correct for certain patients, a more likely position for a natural tooth 3c would be as indicated in FIG. 4a as position 62b. Thus, rather than using an angled piece, such as angled piece 10a or 10b, in the present invention, advantageously implant 20 is rotatable to create an angled profile for the crown, i.e., prosthetic tooth 60. The suitable rotation angle may be as much as 180 degree such that the first and second extension can be suitably oriented for aligning the prosthetic tooth.

Thus, in FIG. 4b, implant 20 is secured to the maxilla in a second position, wherein the first extension 28 is disposed on the lingual side such that prosthetic tooth 60 is then located at position 62b, i.e., the natural tooth position.

Because extension 30 has a significant cut back, stepped socket, i.e., notched area 27a, tooth 60 may be adjusted in multiple positions relative to the implant such, for example, positions 62c or 62d to perfect a preferred alignment that may be even more ideal than the natural tooth position. In other words, implant 20 may be adjusted relative to the maxilla (or mandible) and a prosthetic tooth 60 may be adjusted relative to implant 20 to arrive at an crown alignment that is functional and aesthetically correct while having the implant secured in solid bone. Advantageously, this permits a proper placement of the tooth and provides aesthetic and functional support to other features of the mouth, such as the lips.

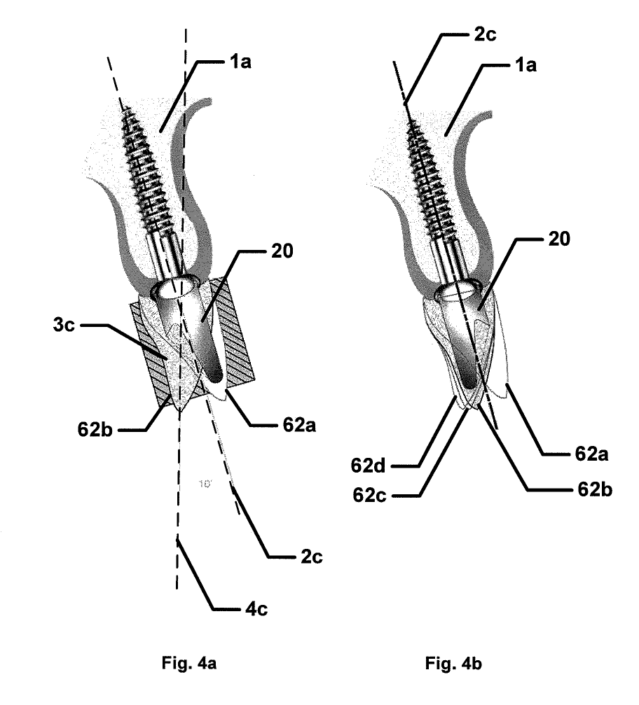

FIG. 5a is a schematic cross-section of a mandible wherein an implant of the present invention has been installed in accordance with one or more embodiments of the present invention. FIG. 5b is a schematic cross-section of a prosthetic tooth comprising a key in accordance with one or more embodiments of the present invention. FIG. 5c is schematic cross-section of a mandible comprising a system wherein the prosthetic tooth of FIG. 5b has been installed on the implant of FIG. 5a in accordance with one or more embodiments of the present invention.

When installing the implant for a mandibular central or lateral incisor, the implant is secured to the mandible of the patient such that the abutment is aligned with the gingiva as medically required. First extension 28 is aligned to the front of the jaw and second extension 30 is placed on the lingual side of the mandible. Key 40 is oriented similar in prosthetic tooth 60 so that bitting 40c is toward a rear surface of the tooth 64a, e.g., surface similar to surface 14, and advantageously having the smaller second extension permits a greater tooth wall thickness 64b. Together, implant 20 and key 40 form a system 70 for implant dentistry.

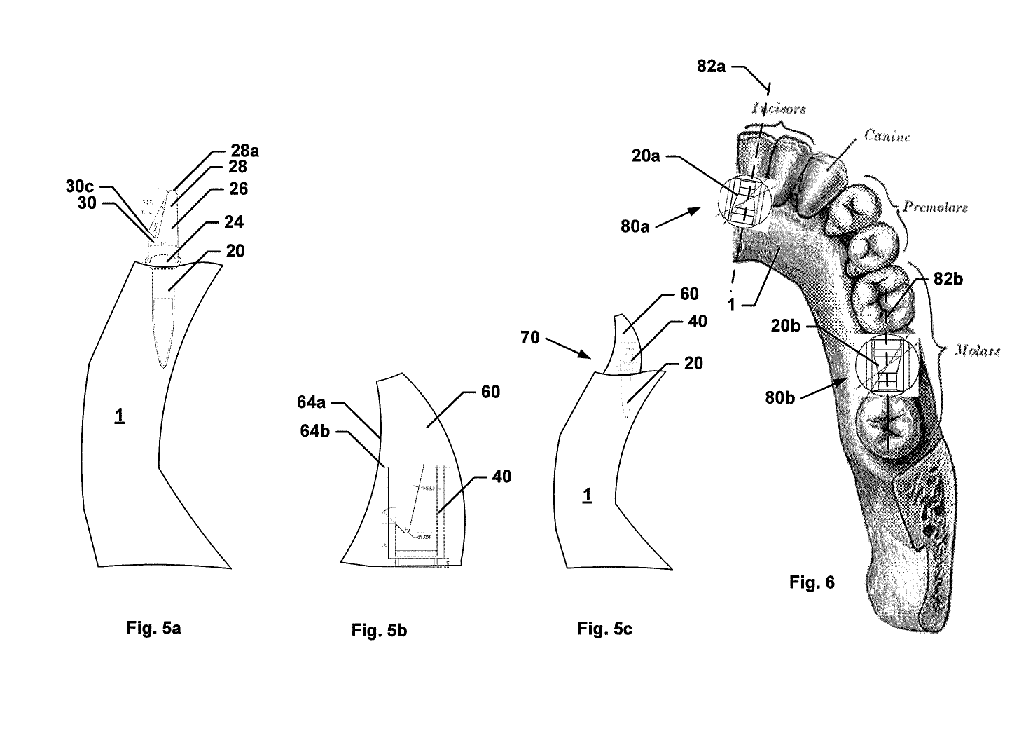

FIG. 6 is a planar view of a mandible wherein an implant of FIG. 2a has been installed in a first and a second direction in accordance with one or more embodiments of the present invention. An implant 20a, which is substantially similar to implant 20, has been installed in a direction 80a that is locally perpendicular to an axis in mandible 1. Therein, first extension 28 is aligned to the front of the jaw and second extension 30 is placed on the lingual side of the mandible top permit an anatomically correct prosthetic tooth shaped as a mandibular central or lateral incisor shape to be mounted in an advantageous manner as taught with respect to FIGS. 5a-5c.

Advantageously, an implant 20b, which is substantially similar to implant 20, has been installed in a direction 80b that is locally parallel to an axis in mandible 1 wherein a tooth other than a mandibular central or lateral incisor is disposed. Therein, first extension 28 and second extension 30 are aligned to be substantially equally spaced from the front of the jaw. Since the location is for a tooth other than a mandibular central or lateral incisor, the particular constraints associated with the shovel shape of the incisor are not needed and the implant may be installed locally parallel to an axis of the jaw, even locally perpendicular to the jaw, i.e., axis 80a, or any convenient axis therein.

While the invention has been described in conjunction with specific embodiments, it is to be understood that many alternatives, modifications, and variations will be apparent to those skilled in the art in light of the foregoing description.

What is claimed is:

1. An implant for supporting a prosthetic tooth in an anatomically correct shape of a tooth, the implant comprising:
a post for securing to a bone of a patient;
an abutment;
a socket comprising a bifurcated stepped shape.

2. The implant of claim 1, wherein the bifurcated stepped shape defines a schematic-anatomical analog to the tooth.

3. The implant of claim 1, wherein the socket comprises a first and a second extension, the first extension being more distal from a floor of the abutment than the second extension.

4. The implant of claim 3, wherein the first extension comprises a rounded peak.

5. The implant of claim 3, wherein the first extension comprises an angled wall connecting a peak of the first extension with a depression adjacent the second extension.

6. The implant of claim 3, wherein a depression is disposed between the first and second extensions.

7. The implant of claim 3, wherein the second depression comprises an angled wall connecting a peak of the first extension with a depression adjacent the first extension.

8. The implant of claim 1, wherein the first extension comprises a transverse wall having an upright wall portion and a canted wall portion.

9. The implant of claim 1, wherein the socket comprises a depression between a first and a second extension.

10. The implant of claim 1, wherein the socket comprises a plurality of lateral side walls that are canted towards each other.

11. The implant of claim 1, wherein the abutment comprises a plurality of lateral channels for receiving a key.

12. An implant socket for supporting a prosthetic tooth in an anatomically correct shape of a tooth, the socket comprising:
a bifurcated stepped shape defining a schematic-anatomical analog to the tooth.

13. The implant socket of claim 9, wherein bifurcated stepped shape comprises a first and a second extension.

14. The implant socket of claim 9, further comprising a plurality of lateral channels for receiving a key.
